(19) United States
(12) Patent Application Publication
(10) Pub. No.: US 2014/0132540 A1
(43) Pub. Date: May 15, 2014

(54) TOUCH PANEL AND INPUT METHOD THEREOF

(71) Applicant: LG INNOTEK CO., LTD., Seoul (KR)

(72) Inventor: Je Won PARK, Seoul (KR)

(73) Assignee: LG INNOTEK CO., LTD., Seoul (KR)

(21) Appl. No.: 14/078,922

(22) Filed: Nov. 13, 2013

(30) Foreign Application Priority Data
Nov. 13, 2012 (KR) 10-2012-0128081

(51) Int. Cl. G06F 3/041

(52) U.S. Cl. CPC G06F 3/041
USPC 345/173

(57) ABSTRACT

Disclosed are a touch panel and an input method thereof. The touch panel includes an active area and an unactive area surrounding the active area, a first sensing unit in the active area, and a second sensing unit in the unactive area. The input method includes touching a first point in an active area, and touching a second point in an unactive area surrounding the active area.

### CROSS-REFERENCE TO RELATED APPLICATION

This application claims the benefit under 35 U.S.C. §119 of Korean Patent Application No. 10-2012-0128081, filed Nov. 13, 2012, which is hereby incorporated by reference in its entirety.

### BACKGROUND

The disclosure relates to a touch panel and an input method thereof.

Appliances using a touch panel provide zoom-in or zoom-out functions for the convenience of a user. However, since the user conventionally touches two points on a screen image of an active area to enlarge or reduce the screen image, the visible field of the screen image is significantly hidden.

### BRIEF SUMMARY

The embodiment provides a touch panel, which can be driven through various input schemes, and an input method thereof.

According to the embodiment, a touch panel includes an active area and an unactive area surrounding the active area, a first sensing unit in the active area, and a second sensing unit in the unactive area.

According to the embodiment, an input method includes touching a first point in an active area and touching a second point in an unactive area surrounding the active area.

As described above, the present embodiment can suggest schemes different from conventional zoom-in and zoom-out schemes for a screen image. In particular, since one input device is used for the screen image of the active area, the sight of a user can be sufficiently ensured. In addition, since various sensors such as a proximity sensor, an infrared sensor, an ultrasonic sensor, and an illuminance sensor are used, sensing can be more finely and accurately performed. Therefore, the screen image can be more delicately zoomed in or zoomed out. Accordingly, the usability and the convenience of the user can be improved.

### BRIEF DESCRIPTION OF THE DRAWINGS

FIG. 1 is a plan view schematically showing a touch panel according to the embodiment.

FIGS. 2 and 3 are plan views to explain an input method according to the embodiment.

### DETAILED DESCRIPTION

In the following description of the embodiments, it will be understood that, when a layer (or film), a region, a pattern, or a structure is referred to as being “on” or “under” another substrate, another layer (or film), another region, another pad, or another pattern, it can be “directly” or “indirectly” on the other substrate, layer (or film), region, pad, or pattern, or one or more intervening layers may also be present. Such a position of the layer has been described with reference to the drawings.

The thickness and size of each layer shown in the drawings may be exaggerated, omitted or schematically drawn for the purpose of convenience or clarity. In addition, the size of elements does not utterly reflect an actual size.

Hereinafter, the embodiment will be described in detail with reference to accompanying drawings.

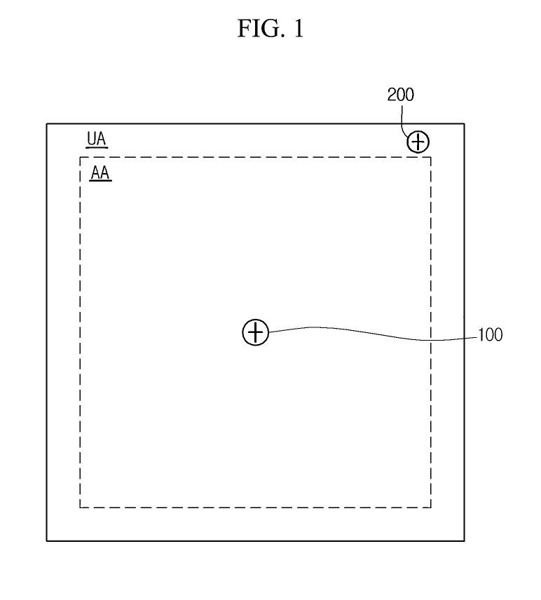

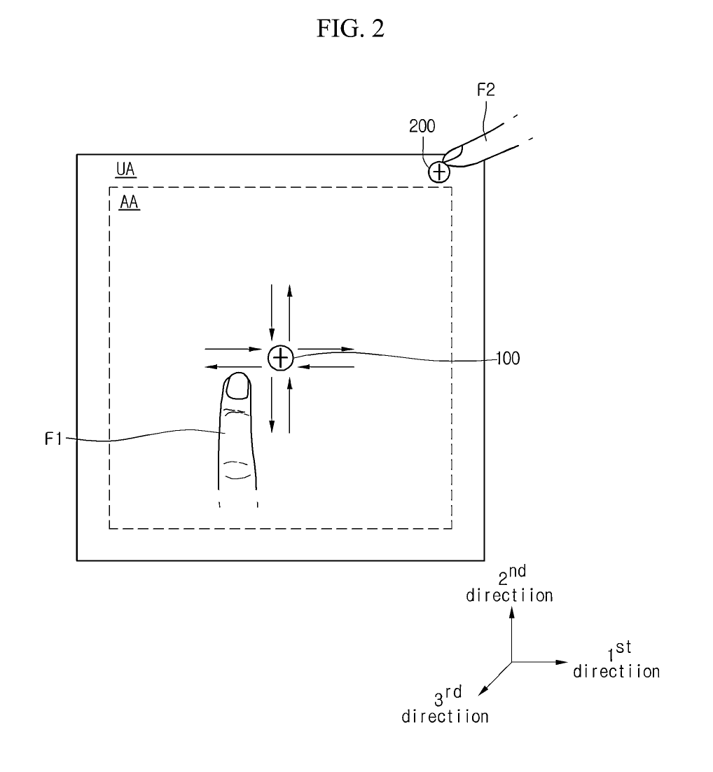

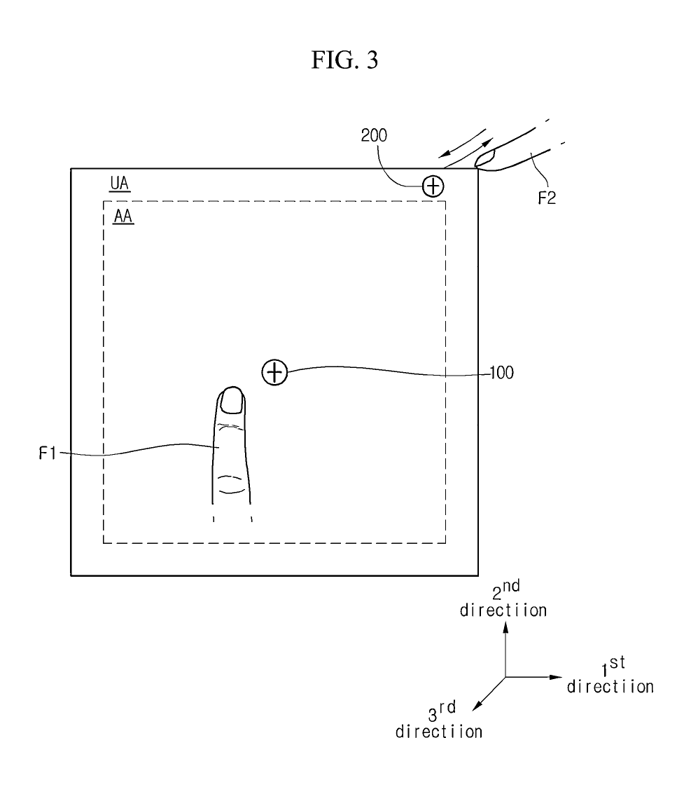

A touch panel and an input method thereof according to the embodiment will be described with reference to FIGS. 1 to 3. FIG. 1 is a plan view schematically showing the touch panel according to the embodiment. FIGS. 2 and 3 are plan views to explain the input method according to the embodiment.

The touch panel according to the embodiment has an active area AA and an unactive area UA defined therein.

A display screen image is provided in the active area AA. In other words, various screen images may be provided to the user in the active area AA.

The active area AA is provided therein with a first sensing unit 100. The first sensing unit 100 may include a transparent electrode to sense a position. The transparent electrode may include a transparent conductive material. The transparent electrode may include various patterns to sense the position.

The transparent electrode may include a metallic oxide such as an indium tin oxide, an indium zinc oxide, a copper oxide, a tin oxide, a zinc oxide, or a titanium oxide. In addition, the transparent electrode may include a nanowire, a carbon nano-tube (CNT), graphene, or various metals. In this case, the first sensing unit 100 may be provided in the shape of a mesh.

In this case, the first sensing unit 100 may be provided at the front surface of the active area AA. In FIG. 1, the first sensing unit 100 is provided in a specific point,

Referring to FIG. 2, when viewed from the top of the active area AA, a first direction and a second direction crossing the first direction are defined on the same plane. The first sensing unit 100 may sense the motion in at least one of the first and second directions. The first direction represents an X axis direction, and the second direction represents a Y axis direction. In other words, the first sensing unit 100 may sense the motion on the same plane. In other words, the first sensing unit 100 may sense 2-D motion.

The unactive area UA surrounds the active area AA. The unactive area UA may be located at an outer peripheral portion of the active area AA. The unactive area UA may be provided therein with a wire and a circuit board to connect the transparent electrode. The unactive area UA may be coated with a material representing a predetermined color such that the wire and the circuit board are not viewed from the outside. Typically, the unactive area UA refers to a bezel.

The unactive area UA is provided therein with a second sensing unit 200. The second sensing unit 200 may include a proximity sensor, an infrared sensor, an ultrasonic sensor, or an illuminance sensor.

Referring to FIG. 3, a third direction crossing the first and second direction is defined, and the second sensing unit 200 senses the motion in the third direction. The third direction refers to a Z axis direction. In other words, the second sensing unit 200 may sense the approximation of an input device. In other words, the second sensing unit 200 may sense 3-D motion.

In detail, if the second sensing unit 200 includes a proximity sensor, the second sensing unit 200 may sense the motion by sensing the variation of capacitance according to the approximation of the input device.

If the second sensing unit 200 includes an infrared sensor (or ultrasonic sensor), the second sensing unit 200 may sense the motion of the input device to cut off the path of the infrared light (ultrasonic wave) in the state that the infrared light (ultrasonic wave) is irradiated. In other words, if the propagation of the infrared light (ultrasonic wave) is cut off at a specific point on the screen image by the input device in the state that the infrared light (ultrasonic wave) is irradiated, the second sensing unit 200 may sense the location by sensing location information of a point in which the infrared light (ultrasonic wave) is cut off.

If the second sensing unit 200 includes an illuminance sensor, the second sensing unit 200 may sense the motion by using the variation in the brightness of light according to the approximation of the input device.

The screen image of the active area AA may be zoomed in or zoomed out through the first sensing unit 100 and the second sensing unit 200. In particular, one input device is located in the screen image of the active area AA, and another input device is located in the unactive area UA, so that the screen image may be zoomed in or zoomed out. For example, a finger of one hand is located in the active area AA, and a finger of the other hand is located in the unactive area UA, so that the screen image can be zoomed in or zoomed out.

Accordingly, schemes different from a conventional zoom-in or zoom-out scheme of a screen image may be suggested. Particularly, since only one input device is used in the screen image of the active area AA, the visible field of the user can be sufficiently ensured. In addition, since various sensors such as a proximity sensor, an infrared sensor, an ultrasonic wave sensor, and an illuminance sensor are used, the motion can be more finely and accurately sensed. Therefore, the screen image can be more delicately zoomed in or zoomed out. Therefore, the usability and the convenient of the user can be improved.

Conventionally, since the screen image can be zoomed in or zoomed out by touching two points on the screen image of the active area AA, the visible field of the screen image is significantly hidden.

Hereinafter, an input method of the touch panel according to the embodiment will be described in detail with reference to FIGS. 2 and 3.

The input method according to the embodiment includes the step of touching a first point 100 and the step of touching a second point 200.

In the step of touching the first point 100, the first point 100 can be touched in the active area AA. In the step of touching the second point 200, the second point 200 can be touched in the unactive area UA.

First, as shown in FIG. 2, a first input device F1 may touch the first point 100, and a second input device F2 may touch the second point 200. In this case, the sequence of the touching of the first point 100 and the touching of the second point 200 may be variable.

In detail, the touch for the first point 100 may be achieved on the plane of the active area AA. In other words, the touch for the first point 100 may be achieved in the first direction or the second direction. The touch for the first point 100 is moved in a predetermined direction while the screen image may be zoomed in or zoomed out. In this case, the second input device F2 may not be moved in the state that the second point 200 is touched.

Meanwhile, as shown in FIG. 3, the first input device F1 may touch the first point 100, and the second input device F2 may touch the second point 200.

In detail, the touch for the second point 200 may be achieved in the third direction. In other words, the touch for the second point 200 is achieved as the second input device F2 is gradually closer to the second point 200 or away from the second point 200. As the second input device F2 is closer to the second point 200 or away from the second point 200, the screen image may be zoomed in or zoomed out. In this case, the first input device F1 may not be moved in the state that the first point 100 is touched.

As described above, since only one input device is used in the screen image of the active area AA, the sight of the user can be sufficiently ensured.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A touch panel comprising:
an active area and an unactive area surrounding the active area;
a first sensing unit in the active area; and
a second sensing unit in the unactive area.

2. The touch panel of claim 1, wherein a first direction and a second direction crossing the first direction are defined on a same plane in the active area, and the first sensing unit senses a motion in at least one of the first and second directions.

3. The touch panel of claim 1, wherein the first sensing unit comprises a transparent electrode.

4. The touch panel of claim 2, wherein a third direction crossing the first and second directions is defined, and the second sensing unit senses a motion in the third direction.

5. The touch panel of claim 1, wherein the second sensing unit comprises one selected from the group consisting of a proximity sensor, an infrared sensor, an ultrasonic sensor, and an illuminance sensor.

6. The touch panel of claim 1, wherein the first and second sensing units zooms in or zooms out a screen image in the active area.

7. An input method comprising:
touching a first point in an active area; and
touching a second point in an unactive area surrounding the active area.

8. The input method of claim 7, wherein the touching of the first point comprises zooming in or zooming out a screen image while moving a touch from the first point.

9. The input method of claim 8, wherein the touch for the first point is performed on a same plane.

10. The input method of claim 8, wherein a first direction and a second direction crossing the first direction are defined on a same plane in the active area, and the touch for the first point is achieved in at least one of the first and second directions.

11. The input method of claim 7, wherein the touching of the second point comprises zooming in or zooming out a screen image while moving a touch from the second point.

12. The input method of claim 11, wherein a third direction crossing first and second directions is additionally defined, and the touch for the second point is achieved in the third direction.

13. The method of claim 11, wherein the touch for the second point is achieved as the touch is closed to or away from the second point.

14. The input method of claim 11, wherein the touch for the second point is achieved in a three dimensional manner.

15. The input method of claim 7, wherein a proximity sensor is provided at the second point and the touch for the second point is achieved by sensing variation of a capacitance.

16. The input method of claim 7, wherein an infrared sensor is provided at the second point and the touch for the second point is achieved by sensing a path of an infrared light.

17. The input method of claim 7, wherein an illuminance sensor is provided at the second point and the touch for the second point is achieved by sensing variation in brightness of a light.

18. The input method of claim 7, wherein a screen image of the active area is zoomed in or zoomed out by touching the first point or the second point.
